(19) United States
(12) Patent Application Publication
(10) Pub. No.: US 2003/0208592 A1
(43) Pub. Date: Nov. 6, 2003

(54) System and method for proactive maintenance through monitoring the performance of a physical interface

(76) Inventor: William Scott Taylor, Duluth, GA (US)

Correspondence Address: F. Drexel Feeling, Jones, Day, Reavis & Pogue, North Point, 901 Lakeside Avenue, Cleveland, OH, 44114, US

(21) Appl. No.: 10/136,604

(22) Filed: May 1, 2002

(51) Int. Cl. G06F 15/173; G06F 15/16

(52) U.S. Cl. 709/224; 709/250

(57) ABSTRACT

A computer-implemented system for generating performance data relating to provisioned physical interfaces in a communication network is provided. The system comprises an exception information retrieval module, a computation module, and graphical output module. The information retrieval module retrieves exception information posted to data records in a database wherein the data records relate to provisioned physical interfaces. The computation module is operative to compute physical interface performance information. The performance information includes a count value, a count threshold indication value, and a rate threshold indication value for at least one physical interface parameter and at least one physical interface. The graphical output module is operative to generate a graphical depiction of the count value for the at least one physical interface parameter and the at least one physical interface.

### BACKGROUND

1. Field of the Invention

This invention relates generally to telecommunication networks. More particularly, the invention relates to a system and method for proactively maintaining a telecommunications network.

2. Description of the Related Art

Proactive maintenance in a telecommunications network allows network operators to anticipate where problems may occur in the future and act proactively to prevent some customer problems from occurring. Proactive activities may also allow a network operator to determine if and help ensure that network performance service level agreements (SLAs) are being met and will continue to be met. Proactive activities preferably include identifying current and potential bottlenecks, inefficient or poorly performing components, potential failures, and others. A current way in which proactive maintenance is performed involves generating a listing that shows the number of exceptions relating to a physical port that were reported in a given time interval and an indication as to whether a count threshold was reached during that time interval. Maintenance personnel can evaluate the physical ports where the count threshold had been reached in a particular time interval to determine if proactive maintenance is indicated.

### SUMMARY

A system and method for monitoring physical layer problems is provided. In accordance with one aspect of the invention defined by the claims, a computer-implemented system for generating performance data relating to provisioned physical interfaces in a communication network is provided. The system comprises an exception information retrieval module, a computation module, and graphical output module. The information retrieval module retrieves exception information posted to data records in a database wherein the data records relate to provisioned physical interfaces. The computation module is operative to compute physical interface performance information. The performance information includes a count value and a count threshold indication value for at least one physical interface parameter and at least one physical interface. The graphical output module is operative to generate a graphical depiction of the count value for the at least one physical interface parameter and the at least one physical interface.

In accordance with another aspect of the invention defined by the claims, a computer-implemented system for generating performance data relating to provisioned physical interfaces in a communication network is provided. The system comprises an exception information retrieval module and a computation module. The information retrieval module retrieves exception information posted to data records in a database wherein the data records relate to provisioned physical interfaces. The computation module is operative to compute physical interface performance information. The performance information includes a count value, a count threshold indication value, and a rate threshold indication value for at least one physical interface parameter and at least one physical interface.

In accordance with another aspect of the invention defined by the claims, a computer-implemented system for generating performance data relating to provisioned physical interfaces in a communication network is provided. The system comprises an exception information retrieval module, a computation module, and graphical output module. The information retrieval module retrieves exception information posted to data records in a database wherein the data records relate to provisioned physical interfaces. The computation module is operative to compute physical interface performance information. The performance information includes a count value, a count threshold indication value, and a rate threshold indication value for at least one physical interface parameter and at least one physical interface. The graphical output module is operative to generate a graphical depiction of the count value for the at least one physical interface parameter and the at least one physical interface.

In accordance with yet another aspect of the invention defined by the claims, a network monitoring system for monitoring the performance of a communication network is provided. The monitoring system comprises a database for storing a plurality of data records relating to provisioned physical interfaces in the communication network, a physical interface exception posting module, and a physical interface performance computation module. The physical interface exception posting module posts physical interface exception information to the data records. The physical interface exception posting module is operative to receive exception messages sent from network elements, determine the physical interface the exception messages relate to, and post information from the exception messages to appropriate physical interface data records. The physical interface performance computation module is operative to generate performance data relating to provisioned physical interfaces in the communication network. The performance computation module comprises an exception information retrieval module, a computation module, and graphical output module. The information retrieval module retrieves exception information posted to data records in a database wherein the data records relate to provisioned physical interfaces. The computation module is operative to compute physical interface performance information. The performance information includes a count value, a count threshold indication value, and a rate threshold indication value for at least one physical interface parameter and at least one physical interface. The graphical output module is operative to generate a graphical depiction of the count value for the at least one physical interface parameter and the at least one physical interface.

### BRIEF DESCRIPTION OF THE DRAWINGS

In order that the invention identified in the claims may be more clearly understood, preferred embodiments of structures, systems and methods having elements corresponding to elements of the invention recited in the claims will be described in detail by way of example, with reference to the accompanying drawings, in which:

FIG. 1 is a schematic diagram of an exemplary section of a frame relay transport network;

FIG. 2 is a chart that illustrates a preferred physical port report;

FIG. 3 is a graph that illustrates a rate increase in the occurrence of a physical interface parameter;

FIG. 4 is a graph that illustrates a rate of occurrence of a physical interface parameter that is close to a count threshold for the parameter;

FIG. 5 is a preferred graphical display of physical interface parameters;

FIG. 6 is a block diagram of a preferred monitoring system;

FIG. 7 is a block diagram illustrating exemplary performance information generated by the preferred monitoring system;

FIG. 8 is a graph that illustrates a change in occurrences of a physical interface parameter; and

FIG. 9 is a flow chart of a preferred method for accumulating performance information for a physical interface for a particular time interval.

### DETAILED DESCRIPTION

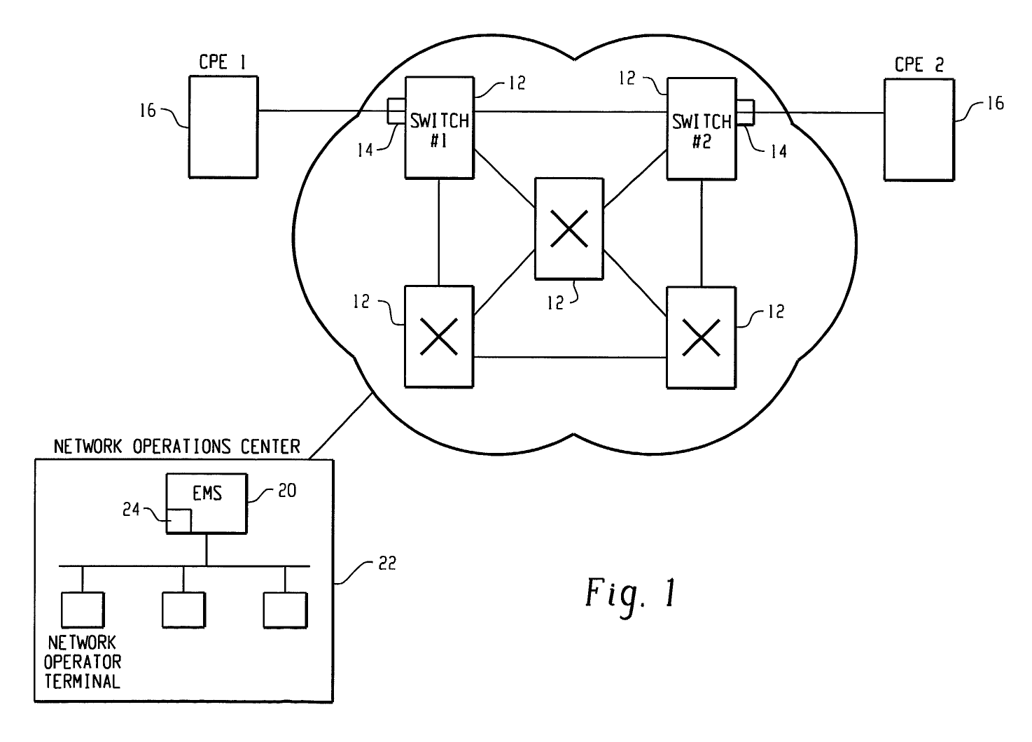

Referring now to the drawings, FIG. 1 is a schematic diagram illustrating an exemplary section of an FR/ATM transport network 10. The transport network 10 comprises a plurality of switching network elements 12 coupled together. The switching network elements 12 include a plurality of physical interfaces 14. The physical interfaces 14 couple to customer premises equipment (“CPE”) 16 such as conventional telephones, facsimile machines, private branch exchanges, voice mail systems, key telephone systems, computers, modems, telephone answering machines, alarm systems, and radio control systems, as well as many other devices via a communication line 18 to provide the CPE 16 with communication channels to other devices.

Also, coupled to the network 10 is an element management system (“EMS”) 20 preferably located in a network operations center 22. The EMS 20 is a platform that allows a network operator to provision various equipment and facilities within the network 10.

The preferred EMS 20 is the NavisCore™ system developed by Lucent. NavisCore™ is a centralized service and network management application that delivers sophisticated, standards-based management and control of Lucent multiservice products—frame relay, SMDS, ATM, and IP switch networks—on a single platform. Featuring the industry's first fully distributed and multiservice element manager, NavisCore™ is a graphically integrated UNIX-based platform that resides on Hewlett Packard's OpenView. It provides a complete network management solution based on Telecommunications Network Management (TNM) standards.

The EMS establishes a virtual channel (“VC”) with various network elements within the network 10 including the switching elements 12. The VCs provide communication paths that allow a network operator to provision equipment and facilities in the network 10 using the EMS and to monitor the status and performance of the equipment and facilities in the network 10. The EMS also maintains a record of the configuration of the network and the status of all the equipment and facilities in the network. Each of the network elements (“NEs”), on demand or when a condition occurs that requires communication, communicates network performance information to the SMS via the VCs.

Among other things, the NEs communicate physical interface performance information to the EMS. Because the physical interface 14 is the physical connection point for customers to connect to the network 10, the monitoring of performance messages relating to a physical interface provides valuable information relating to the quality of service provided to customers. Various types of equipment in various types of transport networks have physical interfaces. For example, physical interfaces are provided in various types of network elements such as switches, DCS, MUXs, NGDLC and others.

Most maintenance activities with respect to the network 10 are performed on a reactive basis. For example, when a customer problem is detected, network operators react to the problem and dispatch service technicians to determine and isolate the problem. Having the ability to proactively maintain the network is desirable.

Proactive maintenance allows the network operators to anticipate where problems may occur in the future and act proactively to prevent some customer problems from occurring. Proactive activities may also allow a network operator to determine if and help ensure that network performance service level agreements (SLAs) are being met and will continue to be met. Proactive activities preferably include identifying current and potential bottlenecks, inefficient or poorly performing components, potential failures, and others.

The EMS employs a preferred monitoring system 24 that monitors physical interface performance. Various physical interface parameters are monitored to provide a network operator with information that can be used to perform proactive maintenance on the network.

Types of physical interface parameters that can be monitored include code violation level (“CVL”), errored seconds level (“ESL”), severely errored seconds level (“SESL”), unavailable seconds period (“UASP”), and others.

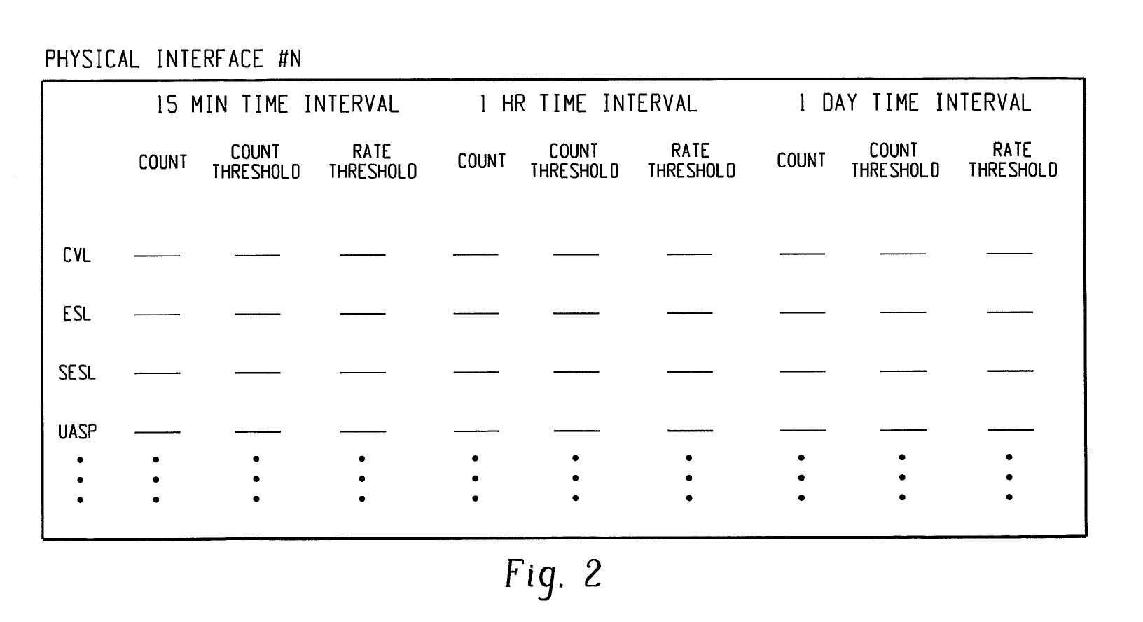

In a preferred monitoring system various physical interface parameters are monitored over a plurality of different time intervals. As illustrated in FIG. 2, preferably each monitored physical interface parameter is monitored over three time intervals: a 15 minute interval, a one hour interval and a twenty four hour interval. In each time interval for each monitored parameter, preferably at least three characteristics relating to the parameter are determined. First, the number of times the specific physical interface parameter was transmitted to the EMS during the time interval is determined. Second, a binary value that indicates whether a threshold value was reached is determined. Third, a rate threshold is determined.

The rate threshold is a measurement that provides network operator personnel with further information regarding a physical interface parameter. Typically, maintenance personnel are only made aware of an alarm condition if the threshold value has been exceeded. The rate threshold measurement can alert the network operator to a condition that may not result in the setting of a time interval threshold but may nonetheless indicate that future problems with the network may occur. The rate threshold is a binary value that indicates whether a physical interface parameter occurrence rate may be of concern.

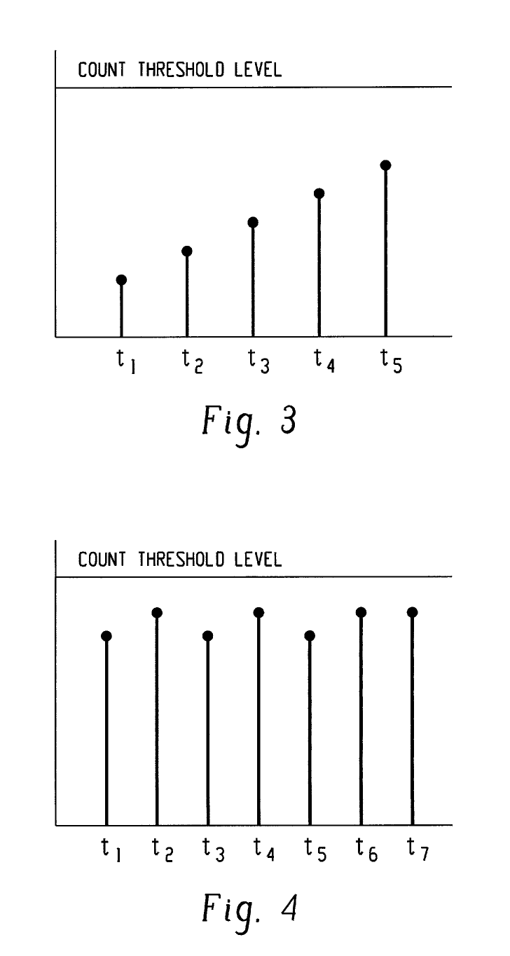

The rate threshold may be determined using various methods. For example, as illustrated in FIG. 3, the rate threshold could be set if the change in number of parameter occurrences per period is increasing at a rate that would indicate that in a certain number of periods if the rate remains constant the threshold for that period would be reached. In the example shown in FIG. 3, the number of occurrences per period t is well below the threshold value, but the number of occurrences is each period is increasing at a rate where in a few periods the threshold value will be reached. Thus, the rate threshold would act as an early warning system in this example.

Also, as illustrated in FIG. 4, the rate threshold could be set if the number of occurrences is not sufficient to set the period threshold value but the number of occurrences over a number of periods causes concern because the number of occurrences is just below the threshold value and stays at that level for a number of periods. If the service degraded a little more, then the number of occurrences could easily exceed the threshold value. The rate threshold provides a way of warning network operators of potential problems before they become problems.

The rate threshold could be set in other ways to provide network operators with a way of predicting if a particular physical interface may in the future have problems. Armed with this additional information, maintenance personnel can proactively service the network before a customer observes a problem.

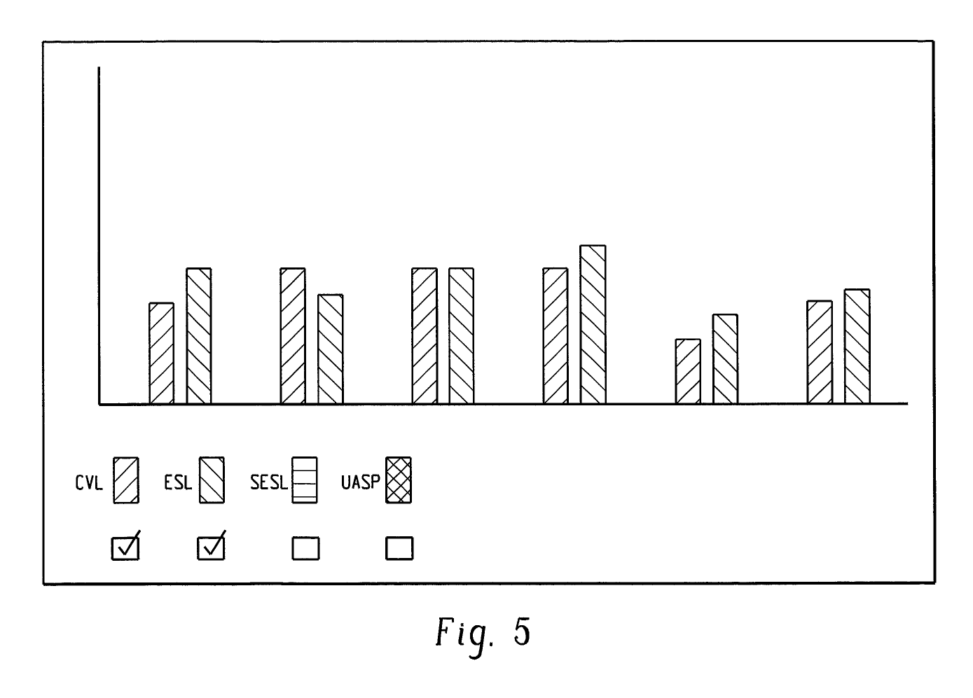

The preferred monitoring system 24 may also preferably be capable of generating graphical displays of physical interface parameter information. As illustrated in FIG. 5, the preferred monitoring system 24 may provide network operators with a graphical depiction of the number of occurrences of various physical interface parameters. A network operator may have the option to view one, some or all of the occurrences of a parameter during a number of time intervals. For example, an operator may have the option of choosing to graphically view the number of ESL and SESL parameters detected in the 15 minute time intervals

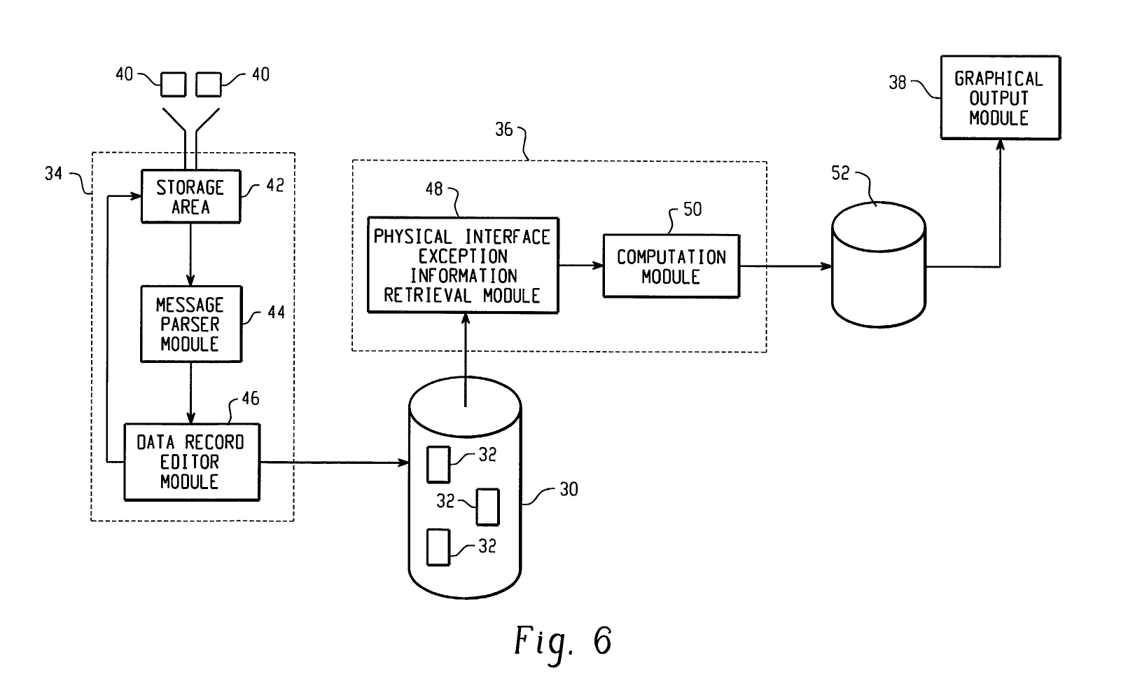

Illustrated in FIG. 6 is a block diagram of a exemplary monitoring system that could be implemented within the EMS. In the description that follows the term module is used. The term module as used herein is a generic term used to describe any entity such as hardware, software, firmware, or a combination of the above that causes the execution of some function.

Preferably, associated with the monitoring system 24 is a storage area 30 which more preferably comprises a database. The database 30 is used to store a number of data records including a physical interface record 32 for each provisioned physical interface within the network.

The illustrated monitoring system 24 includes a physical interface exception posting module 34 for posting physical interface exception or parameter information to the physical interface record 32 that corresponds to the physical interface the exception relates to. The monitoring system 24 also includes a physical interface performance computation module 36 that generates performance data relating to the physical interface based on physical interface exception information posted to the physical interface record. The monitoring system 24 further includes a Graphical output module 38 that is operable to generate graphical displays based on physical interface performance data.

The physical interface exception posting module 34 preferably comprises a storage area 42, a message parser module 44, and a data record editor module 46. The physical interface exception posting module 34 receives exception messages 40 sent from NEs and preferably temporarily stores the messages in a storage area 42. The message parser module 44 determines, by examining the exception message, which physical interface the received exception message relates to. A data record editor module 46, using the output from the message parser module 44, posts the exception message to the physical interface record 32 that corresponds to the physical interface that the exception message pertains to. The physical interface exception posting module 34 performs these functions whenever a physical interface exception message is received.

The physical interface performance computation module 36 retrieves exception information relating to physical interfaces in the network and computes performance information. The physical interface performance computation module 36 preferably comprises an exception information retrieval module 48, which retrieves the exception information relating to physical interfaces in the network, and a computation module 50, which computes performance information.

The physical interface performance computation module 36, computes performance information that describes a physical interface's performance over various time intervals. Preferably, the physical interface performance computation module 36 computes performance information over three different time intervals, a 15 minute time interval, a one hour time interval, and a one day time interval.

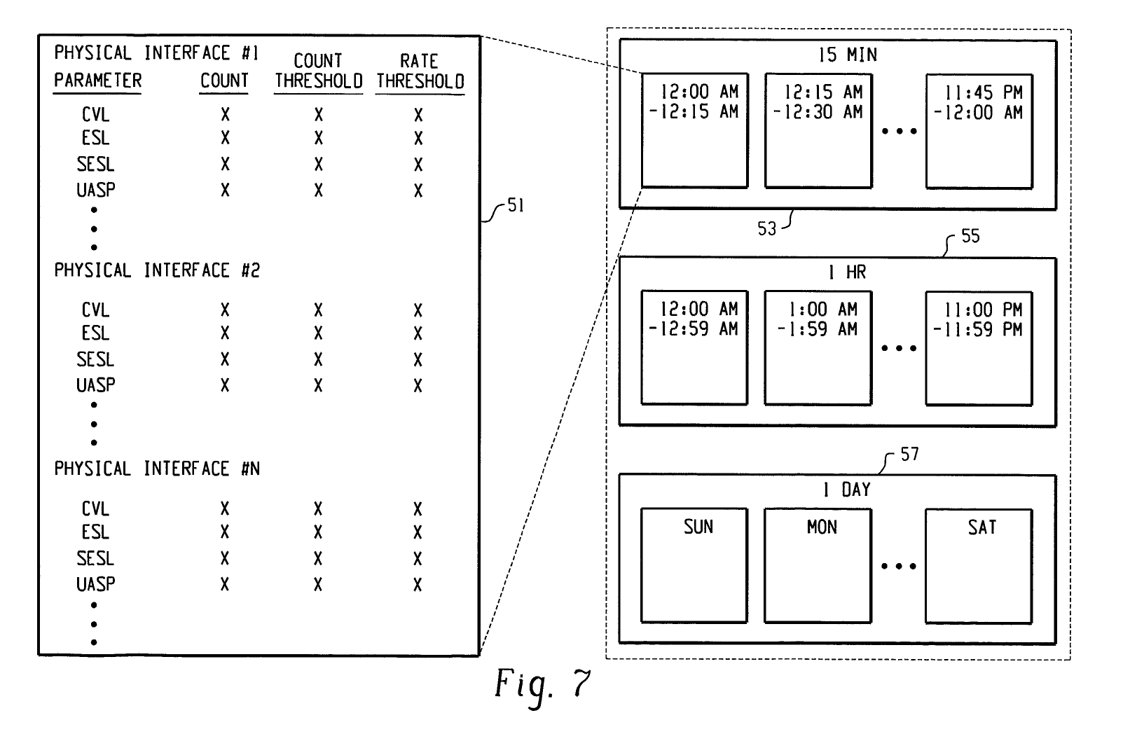

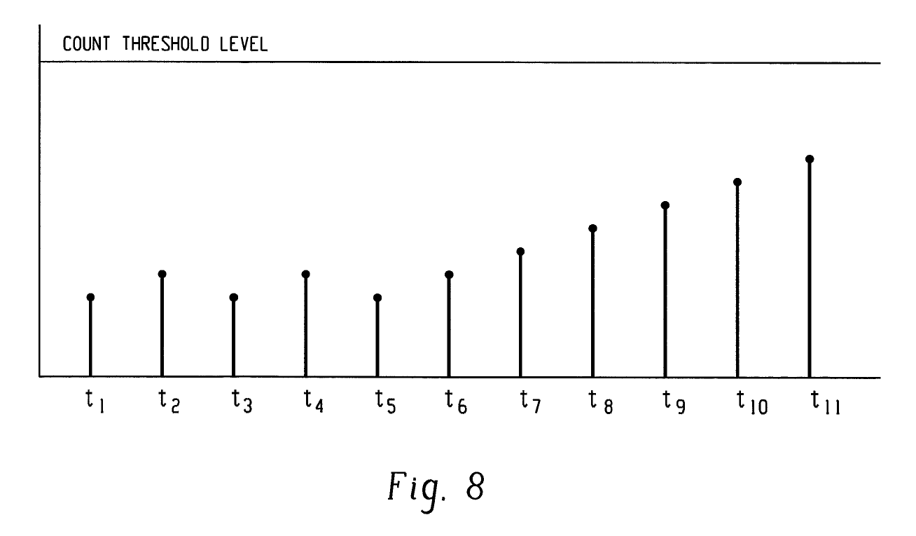

FIG. 7 illustrates the type of performance information provided by the physical interface performance computation module 36. Block 51 illustrates the type of performance information provided for each time interval, which for purposes of this written description will be referred herein as a unit of performance information. Block 53 illustrates that every 15 minutes a 15 minute unit of performance information is computed that describes the physical interfaces performance during that 15 minute time frame. Block 55 illustrates that every hour a one hour unit of performance information is computed that describes the physical interfaces performance during that one hour time frame. And, Block 57 illustrates that every day a one day unit of performance information is computed that describes the physical interfaces performance during that one day time frame.

FIG. 5 also illustrates that the computed performance information is retained for a predetermined period of time. Block 53 illustrates that each 15 minute unit of performance information is retained preferably at least for a 24 hour period. Block 55 illustrates that each one hour unit of performance information is retained preferably at least for a 24 hour period. Block 57 illustrates that each one day unit of performance information is retained preferably at least for a one week period.

The performance information provided by the physical interface performance computation module 36 is preferably retained in a storage area 52. The storage area 52 preferably is one or more files, but optionally could be a location in memory, and/or a location in database, or others. The performance information that is retained in the storage area 52 may be organized in a variety of manners including the way shown in FIG. 5 or other ways.

A unit of performance information preferably comprises a count value, a count threshold indication value, and a rate threshold indication value for each performance parameter that is monitored for each physical interface. In the example illustrated in block 51, at least four performance parameters, CVL, ESL, SESL, and UASP, are monitored for each physical interface. With regard to each performance parameter and each physical interface, a count value, a count threshold indication value, and a rate threshold indication value are computed for the time interval. The count value indicates the number of times during the time interval the particular performance parameter was reported against a particular physical interface. The count threshold indication value indicates whether the count value reached a predetermined threshold level during the time interval. The rate threshold indication value indicates whether a rate threshold level was reached during the time interval. If either the count threshold indication value or the rate threshold indication value is true, indicating that the threshold value had been reached, then a network operator would typically be alerted of the condition.

A graphical output module 68 is provided to allow a network operator to visually view physical interface performance parameter information. The graphical output module 68 is capable of generating graphical displays that can be displayed via a graphical user interface associated with the EMS.

An exemplary output from the graphical output module 68 is shown in FIG. 3. The network operator preferably has an option of choosing to display the count value for one or more performance parameters for a particular physical interface for a chosen period of time. This provides the network operator with the ability to visually view the physical interface performance in a different way to determine if proactive maintenance action may need to be taken.

In the example of FIG. 6, an operator may have chosen to view the CVL 15 minute count for physical interface #1 for the 20 most recent 15 minute intervals. The network operator may observe that for time intervals t₁-t₅ the CVL count was low and steady. The network operator may observe however that beginning at time interval t₆ the CVL count began to steadily increase. Even though the count value may not be high enough to cause the count threshold value to become true, the network operator can observe that something is happening in the network that if not addressed may result in customer service issues. Therefore, the network operator can proactively dispense maintenance personnel to investigate the situation before a customer problem occurs.

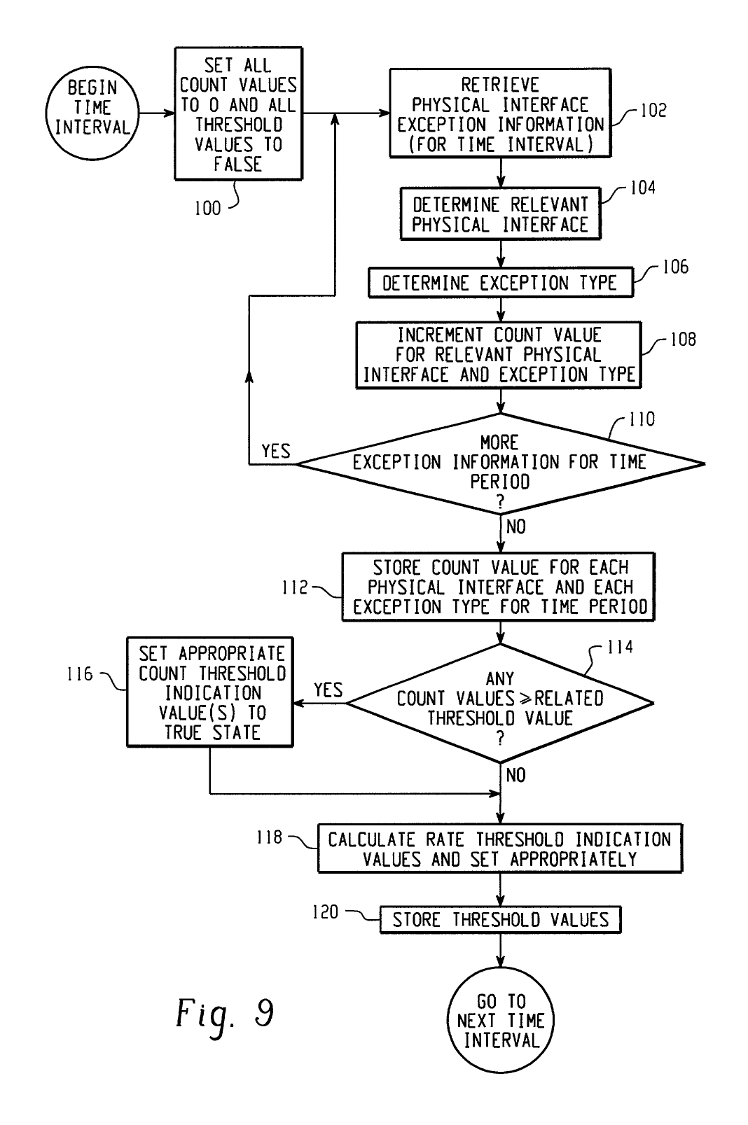

Illustrated in FIG. 9 is an example of a method for accumulating performance information for a physical interface for a particular time interval. The method is applicable to each time interval type. The method assumes that physical interface exceptions have already been reported to the EMS. The method described below is not the only method for accumulating performance information but merely an exemplary method.

At step 100, all count values for each performance parameter and each physical interface are set to zero. Also, all threshold values for each performance parameter and each physical interface are set to a false state.

At step 102, physical interface exception information for the time interval is retrieved.

At step 104, the retrieved physical interface exception information is parsed to determine the physical interface the exception information is relevant to.

At step 106, the retrieved physical interface exception information is parsed to determine the exception type the exception information is relevant to.

At step 108, the count value for the relevant physical interface and exception type is incremented.

At step 110, a decision is made. If more exception information is available, for example, because the time interval has not yet expired if these steps are being performed in real time or because the execution of these steps is resulting in the acquisition of information from one or a few exception messages at a time, then the next step is to go back to step 102. If no more exception information is available for the time interval, then the next step is to go to step 112.

At step 112, the count value for each physical interface and exception type is stored.

At step 114, another decision is made. If any of the count values is greater than or equal to an associated threshold value, then the appropriate count threshold indication value is set to a true state (step 116).

At step 118, rate threshold indication values are calculated and set appropriately. The rate threshold indication values can be calculated using any of the methods described earlier or using other methods.

At step 120, all of the threshold values for the time interval are stored. The system is now ready to begin accumulating performance information for physical interfaces for the next time interval.

Network operator personnel can use the generated performance information in a number of ways. The network operators can view the results on screen or printout results. Optionally, the network operators can employ the Graphical generation module to generate a graphical ID display. Network operator personnel can generate reports to help them identify which portions of the network 10 they would like to have proactive maintenance performed.

Other variations from these systems and methods should become apparent to one of ordinary skill in the art without departing from the scope of the invention defined by the claims. These systems and methods are applicable to monitoring any communication device that has a physical port for transmitting and receiving digital information signals.

The embodiments described herein and shown in the drawings are examples of structures, systems or methods having elements corresponding to the elements of the invention recited in the claims. This written description and drawings may enable those skilled in the art to make and use embodiments having alternative elements that likewise correspond to the elements of the invention recited in the claims. The intended scope of the invention thus includes other structures, systems or methods that do not differ from the literal language of the claims, and further includes other structures, systems or methods with insubstantial differences from the literal language of the claims. Although the embodiments have been described with reference to a frame relay/ATM network, they are applicable to other types of transport networks.

The following is claimed:

1. A computer-implemented system for generating performance data relating to provisioned physical interfaces in a communication network, the system comprising:
an exception information retrieval module for retrieving exception information posted to data records in a database wherein the data records relate to provisioned physical interfaces;
a computation module that is operative to compute physical interface performance information, the performance information comprising a count value, a count threshold indication value, and a rate threshold indication value for at least one physical interface parameter and at least one physical interface; and
a graphical output module that is operative to generate a graphical depiction of the count value for the at least one physical interface parameter and the at least one physical interface.

2. The system of claim 1 wherein the computation module is operative to compute performance information over a plurality of time intervals.

3. The system of claim 1 wherein the computation module is operative to compute performance information over three different time intervals.

4. The system of claim 3 wherein the three different time intervals are a 15 minute time interval, a one hour time interval, and a one day time interval.

5. The system of claim 1 wherein the rate threshold indication value indicates that the rate of occurrence of the physical interface parameter is increasing at too high a rate.

6. The system of claim 1 wherein the rate threshold indication value indicates that the rate of occurrence of the physical interface parameter is consistently just below the level necessary to set the count threshold indication value.

7. A computer-implemented system for generating performance data relating to provisioned physical interfaces in a communication network, the system comprising:
an exception information retrieval module for retrieving exception information posted to data records in a database wherein the data records relate to provisioned physical interfaces; and
a computation module that is operative to compute physical interface performance information, the performance information comprising a count value, a count threshold indication value, and a rate threshold indication value for at least one physical interface parameter and at least one physical interface.

8. The system of claim 7 wherein the rate threshold indication value indicates that the rate of occurrence of the physical interface parameter is increasing at too high a rate.

9. The system of claim 7 wherein the rate threshold indication value indicates that the rate of occurrence of the physical interface parameter is consistently just below the level necessary to set the count threshold indication value.

10. The system of claim 7 further comprising a graphical output module that is operative to generate a graphical depiction of the count value for the at least one physical interface parameter and the at least one physical interface.

11. A computer-implemented system for generating performance data relating to provisioned physical interfaces in a communication network, the system comprising:
an exception information retrieval module for retrieving exception information posted to data records in a database wherein the data records relate to provisioned physical interfaces;
a computation module that is operative to compute physical interface performance information, the performance information comprising a count value and a count threshold indication value for at least one physical interface parameter and at least one physical interface; and
a graphical output module that is operative to generate a graphical depiction of the count value for the at least one physical interface parameter and the at least one physical interface.

12. The system of claim 11 wherein the performance information further comprises a rate threshold indication value for the at least one physical interface parameter and the at least one physical interface.

13. The system of claim 12 wherein the rate threshold indication value indicates that the rate of occurrence of the physical interface parameter is increasing at too high a rate.

14. The system of claim 12 wherein the rate threshold indication value indicates that the rate of occurrence of the physical interface parameter is consistently just below the level necessary to set the count threshold indication value.

15. A network monitoring system for monitoring the performance of a communication network, the monitoring system comprising:
a database for storing a plurality of data records relating to provisioned physical interfaces in the communication network;
a physical interface exception posting module for posting physical interface exception information to the data records, the physical interface exception posting module being operative to receive exception messages sent from network elements, determining the physical interface the exception messages relate to, and posting information from the exception messages to appropriate physical interface data records;
a physical interface performance computation module for generating performance data relating to provisioned physical interfaces in the communication network, the performance computation module comprising,
an exception information retrieval module for retrieving exception information posted to the data records in the;
a computation module that is operative to compute physical interface performance information, the performance information comprising a count value, a count threshold indication value, and a rate threshold indication value for at least one physical interface parameter and at least one physical interface; and
a graphical output module that is operative to generate a graphical depiction of the count value for the at least one physical interface parameter and the at least one physical interface.

16. The system of claim 15 wherein the rate threshold indication value indicates that the rate of occurrence of the physical interface parameter is increasing at too high a rate.

17. The system of claim 15 wherein the rate threshold indication value indicates that the rate of occurrence of the physical interface parameter is consistently just below the level necessary to set the count threshold indication value.

18. A method of accumulating performance information for a physical interface, comprising the steps of:
retrieving physical interface exception information for a time interval;
counting the retrieved physical interface exception information to generate count values wherein each indicates the number of occurrences of a specific physical interface parameter for a specific physical interface;
storing the count values;
setting a count threshold indication value if an associated count meets or exceeds an associated threshold value;
calculating rate threshold indication values; and
storing the threshold indication values.

19. The method of claim 18 wherein rate threshold indication values having a true value indicate that the rate of occurrence of the physical interface parameter is increasing at too high a rate.

20. The method of claim 18 wherein rate threshold indication values having a true value indicate that the rate of occurrence of the physical interface parameter is consistently just below the level necessary to set the count threshold indication value.

21. The method of claim 18 further comprising the step of generating a graphical display of the count value for one or more physical interface parameters for one or more physical interface.
